(19) United States
(12) Patent Application Publication
(10) Pub. No.: US 2004/0110513 A1
(43) Pub. Date: Jun. 10, 2004

(54) Method for signalling a rejected connection request within a mobile radio network, mobile station and mobile radio network

(76) Inventor: Zoltan Csorba, Budapest (HU)

Correspondence Address: BELL, BOYD & LLOYD, LLC, P. O. BOX 1135, CHICAGO, IL, 60690-1135, US

(21) Appl. No.: 10/250,393

(22) PCT Filed: Dec. 14, 2001
(86) PCT No.: PCT/DE01/04718

(30) Foreign Application Priority Data
Dec. 29, 2000 (DE) 100 65 743.5

(51) Int. Cl. H04Q 7/20

(52) U.S. Cl. 455/452.1; 455/466; 455/517

(57) ABSTRACT

A text message is transferred to the calling mobile station, from a memory unit in which the text message is stored, by means of the mobile radio network to signal the rejection of a connection request.

### DESCRIPTION

The invention relates to a method for signaling a rejected connection request within a mobile radio network, a corresponding mobile station and a corresponding mobile radio network.

Rapid technical developments in the field of mobile communication have led in recent years to the development and provision of a large number of different mobile radio services. One particularly well-known and widespread service is what is known as the voice mailbox service, which is an answering system set up in the mobile radio network. This service gives a calling mobile station or a calling subscriber, whose request for a connection to a called mobile station or a called subscriber is rejected, the option of leaving a voice message in a memory unit, which the called mobile station or called subscriber can listen to at a later time.

This is however associated firstly with a cost to the calling mobile station for leaving the voice message in the mailbox and secondly with a cost to the called mobile station for listening to the voice message left in the mailbox.

It is also disadvantageous that within the scope of signaling a rejected connection request generally only the calling mobile station transfers information to the called mobile station by means of such a voice mailbox service. In order also to transfer information from the called mobile station to the calling mobile station using the voice mailbox service, it would be necessary, to change the mailbox announcement on an ad hoc basis, which in turn would be associated with a corresponding call to the mailbox and therefore further costs for the mobile station to be called; the “mobile station to be called” also refers to a mobile station, which becomes a “called mobile station” when a connection request is signaled.

The object of the invention is therefore to specify a method for signaling a rejected connection request within a mobile radio network, a corresponding mobile station and a corresponding mobile radio network, which allow information to be transferred from or about a called mobile station within the scope of signaling a rejected connection request to a calling mobile station in a flexible and low cost manner compared with the prior art.

This object is achieved by means of the features of the independent claims. Advantageous and expedient developments result from the dependent claims.

According to the invention, for signaling rejection of a connection request, a text message is transferred by means of the mobile radio network from a memory unit, in which the text message is stored, to the calling mobile station, without setting up a connection for transferring voice messages.

Transferring a corresponding text message, which is known to cost less than transferring voice messages, allows the uncomplicated and in particular low-cost transfer of information about the called mobile station or from the called mobile station to the calling mobile station. Within the scope of signaling rejection of a connection request the invention also facilitates the transfer of situation-specific information from or about the called mobile station to the calling mobile station, as inputting a text message at the called mobile station and its transfer to the mobile radio network or to the called mobile station is known to be simpler and to cost less than changing the announcement text of a mailbox. This is also demonstrated by the large number of text messages transferred in the known GSM (Global System for Mobile Communications) mobile radio networks by means of SMS (Short Message Service).

In one development of the invention the memory unit, in which the text message for signaling a rejected connection request is stored, is contained in a central unit of the mobile radio network, such as for example a base station controller, a base station, a mobile switching center or a database. This is particularly advantageous for signaling a rejected connection request, if rejection of the connection request is due to the fact that the called mobile station is not logged onto the mobile radio network, because it is switched off for example or because it is located outside the area of coverage of the mobile radio network.

In a further development the memory unit, in which the text message for signaling a rejected connection request is stored, is contained in the mobile station called or to be called. This allows the text message for signaling rejection of a connection request to be adapted to the current situation of the subscriber called or to be called, who may for example be in a meeting, or for the text message for signaling rejection of a connection request to be adapted in response to an ongoing connection request, the urgency of which can be assessed from the call number of the calling mobile station displayed in the display of the called mobile station.

In one embodiment of the invention the text message for signaling rejection of a connection request is also selected automatically from a number of predetermined text messages based on the calling mobile station, for example based on the telephone number of the calling mobile station. This too allows caller-specific signaling of rejection of a connection request.

To achieve the object a mobile station and a mobile radio network are also specified, which are equipped in particular to implement the method according to the invention or one of its developments.

The invention is described in more detail below using preferred embodiments, which are explained using the figures listed below:

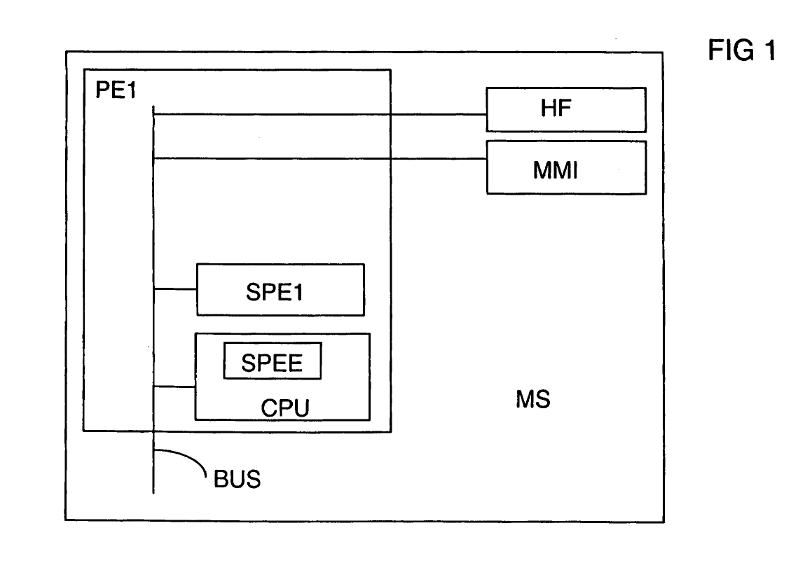

FIG. 1 Block circuit diagram of a mobile station;

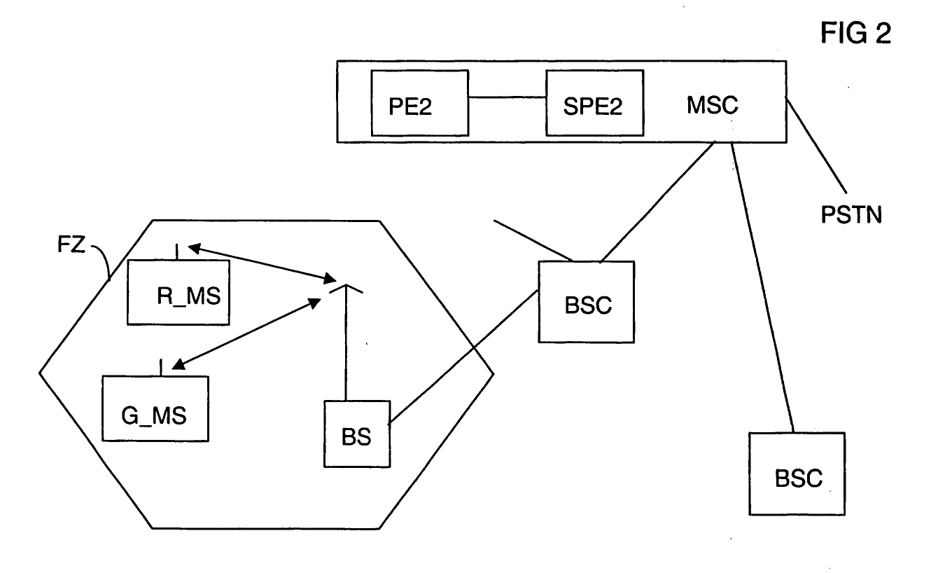

FIG. 2 Block circuit diagram of a mobile radio network;

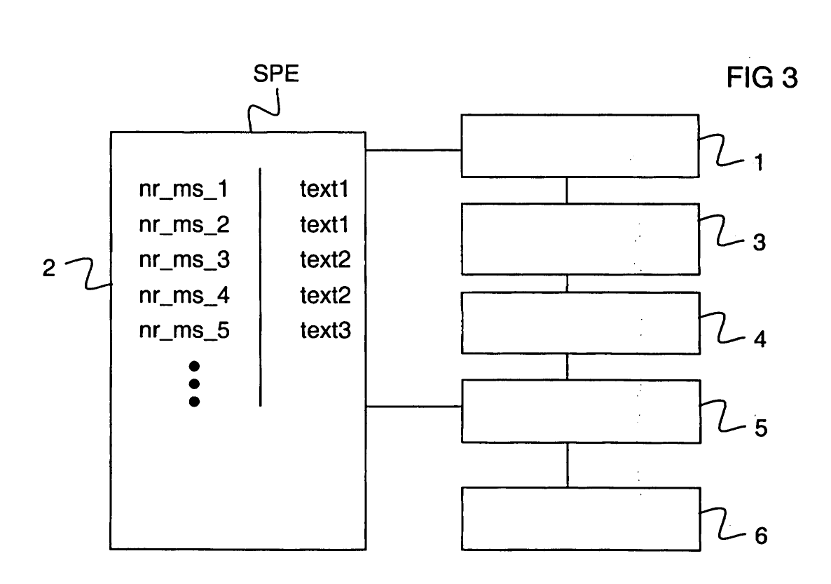

FIG. 3 Simplified flow diagram of a method for signaling a rejected connection request.

FIG. 1 shows a mobile station MS, which contains an operating device MMI, a high frequency device HF and a processor device PE1. The operating device MMI contains a display device, such as for example a graphic display, and activation elements, such as for example keys or soft keys.

To control the mobile station MS and the methods, which are implemented by the mobile station, a program-controlled processor device PE1, such as for example a micro-controller, is provided, which can also include a processor CPU and a memory unit SPE1. The different components can exchange data with the processor CPU via a bus system BUS or input/output interfaces and where necessary suitable controllers.

Depending on the variant of the configuration, the memory unit SPE1, which may also be one or more volatile and/or non-volatile memory modules, or parts of the memory unit SPE1 can be set up as part of the processor device PE1 (shown in the figure) or as an external memory unit (not shown in the figure), located outside the processor device PE1 or even outside the mobile station MS and connected to the processor device PE1 by means of suitable interfaces or a suitable bus system. The memory unit can also be set up at least partially on a subscriber identification module.

The program data, such as for example the control commands or control procedures which are used to control the mobile station, are stored in the memory unit SPE1. Text messages for signaling a rejected connection request and the assigned information required for their automatic selection, such as for example call numbers of calling mobile stations, can also be stored in the memory unit SPE1. The processor device PE1 can also be equipped to convert spoken language to a text message using voice recognition methods SPEE known per se.

FIG. 2 shows a cellular mobile radio network, which comprises a number of mobile switching centers MSC, which are networked with each other or allow access to a fixed network PSTN. Each of these mobile switching centers MSC is also connected to at least one base station controller BSC, which can also be established by a data processing system. Each base station controller BSC is in turn connected to at least one base station BS. One such base station BS is a radio station, which can set up a radio link to other radio stations, known as mobile stations G_MS, R_MS via a radio interface. Information or data can be transferred between the mobile stations G_MS, R_MS and the base station BS assigned to these mobile stations G_MS, R_MS by means of radio signals. The data can be transferred according to methods of data transfer known per se. The range of the radio signals from a base station essentially defines a radio cell FZ. The totality of all radio cells of a mobile radio network thereby determines the area of coverage of the mobile radio network.

Depending on the variant of the embodiment a processor device PE2 and a memory unit SPE2 can be integrated in a base station controller BSC, a mobile switching center MSC (shown in the figure) or another central unit of the mobile radio network according to the integration of a processor device PE1 and a memory unit SPE1 in a mobile station as described above and these can be used to control at least the inventive signaling of rejected connection requests.

To transfer data, in particular voice data, a connection is set up from a calling mobile station R_MS to a called mobile station G_MS according to methods known per se, generally by means of the mobile radio network. The following instances may also result in rejection of the request (connection request) of a calling mobile station R_MS for a connection to be set up to a called mobile station G_MS:

a) the called mobile station G MS is switched off;

b) the called mobile station G_MS is switched on but is outside the area of coverage of the mobile radio network;

c) the called mobile station G_MS is switched on, is within the area of coverage of the mobile radio network, but the called mobile station G MS rejects the connection request of the calling mobile station.

In at least one or all of these three instances a text message for signaling a rejected connection request is transferred to the calling mobile station R_MS. The text message can be transferred for example either by means of a short message service known per se of the mobile radio network or by means of signaling sub-procedures incorporated specifically for this purpose in the signaling procedures of the mobile radio network.

Information about whether a connection request should be rejected can be determined according to methods known per se. The determination and processing of information about whether a text message and if so, which text message is transferred by means of the mobile radio network in which instances to which calling mobile station R_MS for signaling rejection of a connection request, is also covered by the following embodiments of the invention.

The method shown in FIG. 3 allows signaling of a rejected connection request by means of a text message text1, which is selected automatically from a number of predetermined text messages text 1,2,3 based on the calling mobile station or its call number nr_ms_1.

In stage 1 of the method a text message text1 for signaling a rejected connection request is input at a mobile station to be called, whereby the text message text1 can be generated either using a keypad or using voice recognition by converting spoken language to text. This input text message text1 is stored in stage 2 as one of a number of text messages text1, 2, 3 in a memory unit SPE. The input text message text1 can for example be assigned to one or more call numbers nr_ms_1,2 of possible calling mobile stations, to allow caller-specific signaling of a rejected connection request. The call numbers can be the call numbers input in the telephone directory of the mobile station to be called.

If a calling mobile station R_MS now signals a request for connection to a called mobile station G_MS to a mobile radio network in stage 3 and the connection request is rejected in stage 4 for one of the three reasons specified above, the text message text1, which is assigned to the call number nr_ms_1 of the calling mobile station R_MS is read from the memory unit SPE to signal rejection of the connection request in stage 5 and is then transferred in stage 6 from the memory unit SPE to the calling mobile station R_MS via the mobile radio network. Other text messages text2, 3 can be assigned to other call numbers nr_ms_3, 4, 5 of calling mobile stations. The memory unit SPE can be part of the mobile station MS or part of a central unit of the mobile radio network.

In another variant of the embodiment of the invention the memory unit is contained in a central unit of the mobile radio network and a reason for rejecting the connection request is assigned to the various text messages. If for example the called mobile station is outside the area of coverage of the mobile radio network, the following text message for signaling rejection of the connection request is automatically transferred from the number of text messages to the calling mobile station: “The mobile station called is temporarily outside the area of coverage of the mobile radio network”. If for example the called mobile station was switched off within the area of coverage of the mobile radio network, the following text message for signaling rejection of the connection request is automatically transferred to the calling mobile station from the number of text messages: “The mobile station called is temporarily switched off”.

Finally in another variant of the embodiment of the invention a subscriber does not wish to be disturbed during a meeting lasting until 18.30 hrs. The subscriber therefore inputs the following text message on his mobile station before the meeting: “I will be available again after 18.30 hrs”. This text message is stored in a memory unit of the mobile station. If a calling mobile station now requests a connection to the mobile station of said subscriber, who does not wish to be disturbed during the meeting, the corresponding message for signaling rejection of a connection request is transferred to the calling mobile station—either automatically or after confirmation by key operation at the called mobile station by the called subscriber, depending on the variant of the embodiment thereby informing the calling subscriber that the subscriber he wishes to call will not be available until after 18.30 hrs. The requested connection is not set up.

In addition to the variants of the embodiments of the invention described above, a number of further variants come within the scope of the invention which are not described here in more detail but which can be deployed easily in practice on the basis of the embodiments described.

1. Method for signaling a rejected connection request within a mobile radio network,
in which a text message (textl) for signaling a rejected connection request is stored in a memory unit (SPE1, 2) (2),
in which a calling mobile station (R_MS) signals a request for connection to a called mobile station (G_MS) to a mobile radio network (3),
in which the connection request is rejected (4) and
in which for signaling rejection of the connection request the text message (text1) for signaling a rejected connection request is transferred from the memory unit (SPE1, 2) to the calling mobile station (R_MS) by means of the mobile radio network (6).

2. Method according to claim 1,
in which the memory unit (SPE2) is contained in a central unit (MSC) of the communication network.

3. Method according to claim 1,
in which the memory unit (SPE1) is contained in the mobile station to be called (R_MS).

4. Method according to one of the preceding claims,
in which the text message (text1) is selected automatically from a number of predetermined text messages (text1, 2, 3) based on the calling mobile station (R_MS) (5).

5. Method according to claim 2,
in which the text message (text1) is selected automatically from a number of predetermined text messages (text1, 2, 3) based on whether the called mobile station (G_MS) is switched off or is outside the area of coverage of the mobile radio network.

6. Method according to one of the preceding claims,
in which the text message (text1) is input at a mobile station to be called (R_MS) (1).

7. Method according to claim 6,
in which voice input at a mobile station to be called (R_MS) is converted to the text message (text1) by means of voice recognition.

8. Method according to one of the preceding claims,
in which the text message (text1) is transferred at least partially by means of a short message service of the mobile radio network.

9. Mobile station (G_MS),
with an input device (MMI) for inputting a text message (text1) for signaling a rejected connection request,
with a memory unit (SPE1) to store a text message (text1), and
with a processor device (PE1), which is equipped so that for signaling rejection of a connection request the text message (text1) for signaling a rejected connection request is transferred from the memory unit (SPE 1) to the calling mobile station (R_MS) by means of the mobile radio network.

10. Mobile station (G_MS) according to claim 9,
with a processor device (PE1), which is equipped so that the text message (text1) is selected automatically from a number of predetermined text messages (text1, 2, 3) based on the calling mobile station (R_MS).

11. Mobile station (G_MS) according to one of claims 9 or 10,
with a voice recognition device (SPEE) for inputting a text message (text1) using voice.

12. Mobile radio network
with means (BS, BSC, MSC) for setting up a connection from a calling mobile station (R_MS) to a called mobile station (G_MS),
with a memory unit (SPE2) for storing a text message (text1) for signaling a rejected connection request,
with a processor device (PE2), which is equipped so that for signaling rejection of a connection request the text message (text1) for signaling a rejected connection request is transferred from the memory unit (SPE2) to the calling mobile station (R_MS) by means of the mobile radio network.

13. Mobile radio network according to claim 12,
with a processor device (PE2), which is equipped so that the text message (text1) is selected automatically from a number of predetermined text messages (text1, 2, 3) based on whether the called mobile station (G_MS) is switched off or is outside the area of coverage of the mobile radio network.

14. Mobile radio network according to claim 12,
with a processor device (PE2), which is equipped so that the text message (text1) is selected automatically from a number of predetermined text messages (text1, 2, 3) based on the calling mobile station (R_MS).
